(19) United States
(12) Patent Application Publication
(10) Pub. No.: US 2005/0023431 A1
(43) Pub. Date: Feb. 3, 2005

(54) Bike repair station with inner tube vending machine and air compressor

(76) Inventor: Richard Clayton Coffelt, Denver, CO (US)

Correspondence Address: The Law Office of Craig W. Barber, PO Box 16220, Golden, CO, 80402-6004, US

(21) Appl. No.: 10/631,839

(22) Filed: Jul. 30, 2003

(51) Int. Cl. F16M 1/00

(52) U.S. Cl. 248/637

(57) ABSTRACT

The present invention teaches a machine combining the operations of a bicycle repair station and a bicycle product vending machine. The device combines a bike rack, a tether and at least one bike tool secured to the device by the tether. It may further comprise an air compressor, advertising, and a base to secure it to the ground, a concrete pad, to a bike rack not directly secured to the machine or other ancillary devices, and may be solar powered for use in locations not having electricity. In a method embodiment a machine offering bike related products and repair facilities may be located at high bike traffic locations such as local, state or national parks, bike paths, velodromes, etc. Products dispensed may particularly include inner tubes, pumps, brake pads, nuts, bolts, tools, helmets, lights, safety devices, rain gear, weather related apparel and gear, and merchandise for the rider as well as the bike.

### FIELD OF THE INVENTION

This invention relates generally to bicycle repair stations and specifically to a bicycle repair station which provides a work stand, vends inner tubes and other bicycle repair related items, as well as offering compressed air to users and providing a unique point of sale for bike related products.

### BACKGROUND OF THE INVENTION

The increasing popularity of bicycle sports puts a greater number of people on bicycles in a greater number of locations. For example, the development of the mountain bike in the last few decades has put large number of bicyclists in various semi-wild locations at an increasing distance from built up areas. Other factors have also led to greater numbers of bicyclists being present in relatively new locations. The dramatic reduction in violent crime during the 1990's, combined with a steady increase in bicycle path miles available in urban areas resulted in bicyclists exploring in great numbers urban areas they had previously eschewed. Other examples abound: bicycle messenger services in business districts have proliferated, BMX tracks, velodromes are popping up and so on.

One result, however, is that these bicyclists are finding themselves at an increasing distance from the support facilities needed to repair and maintain a bicycle. For example, while a gasoline station is present on most every corner, a typical town of 30,000 people might have only a single bicycle shop. A bicyclist finding themselves with a malfunction a few miles outside of town may be in for a long walk. Bike shops are commonly scattered very thinly across urban areas, and tend to be even more sparse in the actual downtown of many cities; yet the downtown or business district is an increasingly viable bicycle destination.

Another aspect of this problem is that bike shops become sales destinations which compete on a basis other than price. The overhead necessary to maintain a specialty shop, sales staff, and an adequate stock of expensive equipment combine to require high mark up on many items.

The lack of low cost bike repair facilities at the actual sites at which bikers need them has been a substantially unrecognized problem up until the present time, as the following professional search results will show. No combination of the patents listed below teaches vending of bicycle repair facilities and bike repair related items like inner tubes, energy bars, etc.

In general, there were a number of portable or semi-portable stands. U.S. Pat. No. 5,996,814 issued Dec. 7, 1999 to Workman et al for BICYCLE WORKSTAND; U.S. Pat. No. 5,842,581 issued Dec. 1, 1998 to Graefe for PORTABLE BICYCLE REPAIR RACK; U.S. Pat. No. 5,765,821 issued Jun. 16, 1998 to Janisse et al for portable BICYCLE REPAIR STAND; and U.S. Pat. No. 5,497,967 issued Mar. 12, 1996 to Gantois for BICYCLE REPAIR STAND all disclose one form or another of a portable or semi-portable bike rack. These items are used to hold a bicycle while it is being worked on.

U.S. Pat. No. 4,170,307 issued Oct. 9, 1979 to Maeder for SERVICE MODULE at least teaches a stand for holding a bike, with an overhead module for carrying tools and an air compressor. It is thus equipped with both tools and a stand, and is designed to remain in one place. But even this patent does not disclose tethering of tools to the stand, does not teach any vending aspect and lacks the additional sale of related items at the station, such as tools, parts, etc.

Thus, an unrecognized and unmet need exists for some type of device to be placed at the locations at which bicyclists are actually present when they have need for bicycle supplies and repair facilities.

In addition, dramatic simplification of the sales process and overhead requirements allows a commercially viable reduction in prices of bike related items in comparison to the present supply situation.

### SUMMARY OF THE INVENTION

General Summary

The present invention teaches a machine combining the operations of a bicycle repair station and a bicycle product vending machine. The device of the machine combines a bike rack, a tether and at least one bike tool secured to the device by the tether. The invention may further comprise an air compressor, advertising, and a base to secure it to the ground, a concrete pad, to a bike rack not directly secured to the machine or other ancillary devices. The device may be solar powered for use in locations not having electrical supplies. In a method embodiment of the invention, a machine offering bike related products and repair facilities may be located at high bike traffic locations such as local, state or national parks, bike paths, velodromes, BMX tracks, etc. Products dispensed may particularly include inner tubes, pumps, brake pads, nuts, bolts, tools, helmets, lights, safety devices, weather related gear and apparel, and merchandise for the rider as well as the bike.

Summary in Reference to Claims

It is therefore one aspect, advantage, objective and embodiment of the present invention to provide a bicycle repair station comprising: a bicycle support dimensioned and configured to support a standard bicycle; a vending device, the bicycle support and vending device being attached to one another; at least one bicycle repair tool, a tether, the bicycle repair being attached to the tether, the tether being attached to one member selected from the group consisting of: the vending device, the bicycle support, and combinations thereof.

It is therefore one aspect, advantage, objective and embodiment of the present invention to provide a bicycle repair station further comprising: an air compressor attached to one member selected from the group consisting of: the vending machine, the bicycle support.

It is therefore one aspect, advantage, objective and embodiment of the present invention to provide a bicycle repair station wherein the bicycle repair tool is one member selected from the group consisting of: tools optimized for bicycle usage, tire irons, spoke butterflies/wrenches, “Allen” wrenches, other wrenches, drivers, sockets, screw drivers, and combinations thereof.

It is therefore one aspect, advantage, objective and embodiment of the present invention to provide a bicycle repair station wherein the vending device dispenses at least one item selected from the group consisting of: bicycle tires, bicycle inner tubes, bicycle repair tools, bicycle lights, bicycle brake pads, bicycle components and combinations thereof.

It is therefore one aspect, advantage, objective and embodiment of the present invention to provide a bicycle repair station wherein the bicycle repair station has a weight sufficient to deter easy removal.

It is therefore one aspect, advantage, objective and embodiment of the present invention to provide a bicycle repair station further comprising: a concrete apron, the bicycle repair station secured thereto.

It is therefore one aspect, advantage, objective and embodiment of the present invention to provide a bicycle repair station comprising: a bicycle support dimensioned and configured to support a standard bicycle; a vending machine, the bicycle support and vending device being attached to one another; an air compressor attached to one member selected from the group consisting of: the vending machine, the bicycle support.

It is therefore one aspect, advantage, objective and embodiment of the present invention to provide a bicycle repair station wherein the bicycle repair tool is one member selected from the group consisting of: tools optimized for bicycle usage, tire irons, spoke butterflies, wrenches, screw drivers, and combinations thereof.

It is therefore one aspect, advantage, objective and embodiment of the present invention to provide a bicycle repair stand wherein the vending device dispenses at least one item selected from the group consisting of: bicycle tires, bicycle inner tubes, bicycle repair tools, bicycle lights, bicycle brake pads, bicycle components and combinations thereof.

It is therefore one aspect, advantage, objective and embodiment of the present invention to provide a bicycle repair station wherein the bicycle repair station has a weight sufficient to deter easy removal.

It is therefore one aspect, advantage, objective and embodiment of the present invention to provide a bicycle repair station further comprising: a concrete apron, the bicycle repair station secured thereto.

It is therefore one aspect, advantage, objective and embodiment of the present invention to provide a method of selling bicycle equipment, comprising: providing a machine vending such bicycle equipment, providing at least one member selecting from the group consisting of: a bicycle support dimensioned and configured to support a standard bicycle, an air compressor, bicycle repair tools, and combinations thereof; securing the provided devices in a manner sufficient to deter removal; and selling such bicycle equipment by means of the vending machine.

It is therefore one aspect, advantage, objective and embodiment of the present invention to provide a method further comprising a first step of: locating a first place having a relatively high volume of bicycle use; wherein the steps of providing devices further comprise providing such devices at the first place.

### BRIEF DESCRIPTION OF THE DRAWINGS

FIG. 1 is a front view of a first embodiment of the invention.

FIG. 2 is a bottom oblique view of the first embodiment of the invention.

FIG. 3 is a front view of a second embodiment of the invention.

FIG. 4 is an elevational oblique view of a third embodiment of the invention.

FIG. 5 is a front view of the third embodiment of the invention.

FIG. 6 is top view of the third embodiment of the invention.

FIG. 7 is an elevational oblique view of an alternative embodiment showing the device in use, with a bicycle on the rack.

### INDEX OF PARTS

100 First embodiment
102 Vending machine body
104 Bike rack
106 Air hose nozzle
108 Vending subsystem money receiver
110 Merchandise selection button
112 Bike rack hook
114 Bike rack support
116 Vending subsystem product dispenser
118 Base
120 Advertising
200 Second embodiment
202 Vending machine body
204 Bike rack
206 Air hose nozzle
208 Vending subsystem money receiver
210 Merchandise selection button
216 Vending subsystem product dispenser
220 Advertising
230 Tether
232 Bike repair tool
300 Third embodiment
302 Vending subsystem money receiver
304 Merchandise selection button
306 Vending subsystem product dispenser
308 Air compressor
310 Air compressor feet
312 Advertising
314 Secondary advertising
316 Air hose
318 Nozzle
320a, 320b Bike racks
322 Dip 322
324 Base plate
326 Rear
328 Left side
330 Front side
332 Right side
400 Alternative embodiment
440 Bike under repair

### DETAILED DESCRIPTION

FIG. 1 is a front view of a first embodiment 100 of the invention. FIG. 2 is a bottom oblique view of the first embodiment 100 of the invention. Vending machine body 102 has one side bike rack 104. Bike rack 104 is dimensioned and configured to hold a bicycle during repair or maintenance operations. Air hose nozzle 106 is connected to an air hose and air compressor, not visible as both are inside of the body 102. In this embodiment, the air hose is retractable and spring loaded and may be pulled out when compressed air is desired by a user.

Vending subsystem money receiver 108 may be bill scanner, a coin receiver, a credit card/debit card/bank card reader, a bar code scanner and any combination thereof. Receiver 108 allows users to input fairly substantial amounts of money, as while some products and merchandise vended by the machine may be quite inexpensive, some may be relatively expensive.

Merchandise selection button 110 is an example of the merchandise selection buttons and methods available on vending machines. Products dispensed may particularly include inner tubes, pumps, brake pads, nuts, bolts, tools, helmets, lights, safety devices, and merchandise for the rider as well as the bike.

Bike rack hook 112 is typical of hooks dimensioned and configured to support a bike. This particular hook shape and size is adapted to be slipped through the frame of the bike in several different ways: right side up, upside down, tilted, etc. Obviously other types of bicycle support may be used: flat surfaces, clamps, etc. Bike rack support 114 (FIG. 2) is a triangular metal member used to take the weight of a bike resting upon hook 112.

Vending subsystem product dispenser 116 may be any of a number of standard types of chute/flap combinations, an open bin, or another type of device optimized for use with bike products. As an example, inexpensive pumps may be dispensed, requiring a somewhat longer product dispenser 1 16. Other subsystems of the vending structures of the overall device may be optimized for bike products: the racks on which products are stored, bins, slides, access panels, etc.

Base 118 may be employed as a security device to prevent easy theft: base 118 may be concrete, heavy metal, secured to an immovable object, etc. Bike support 104 may be connected to base 118 rather than vending body 102.

The device may also have a weight sufficient to deter easy removal. In general, this means the device may be heavy enough to prevent easy manual handling by a small group without machinery.

Advertising 120 may be used to indicate the origin of the goods and services offered by the machine itself, or it could indicate other items. Sale of advertising space upon device 100 could dramatically increase profitability and reduce overhead costs associated with dispensed items.

FIG. 3 is a front view of a second embodiment 200 of the invention. In this presently preferred embodiment 200 and best mode presently contemplated for carrying out the invention, Vending machine body 202, bike rack 204, air hose nozzle 206, vending subsystem money receiver 208, merchandise selection button 210, vending subsystem product dispenser 216, advertising 220, and other features are much as discussed with respect to the previous embodiment. However, tether 230 is used to secure bike repair tool 232 to the device. By this means, a virtually complete range of self-service repair options may be offered. Tools which are optimized for bicycle usage may be offered: tire irons, spoke butterflies, etc, as well as tools of a more general nature: wrenches, screw drivers, etc.

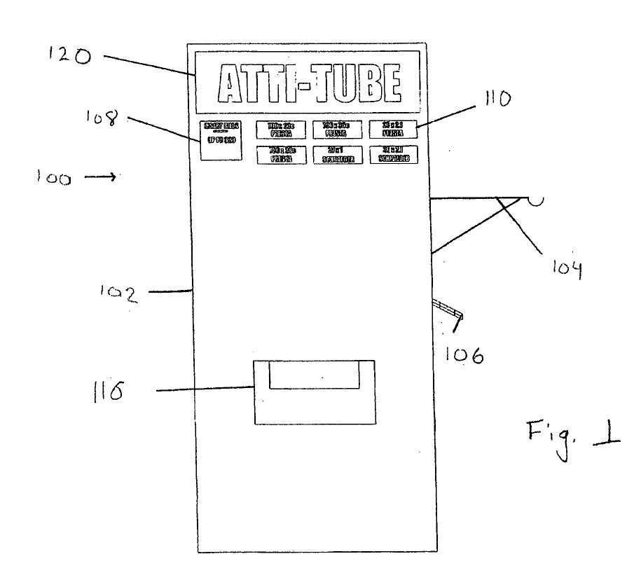

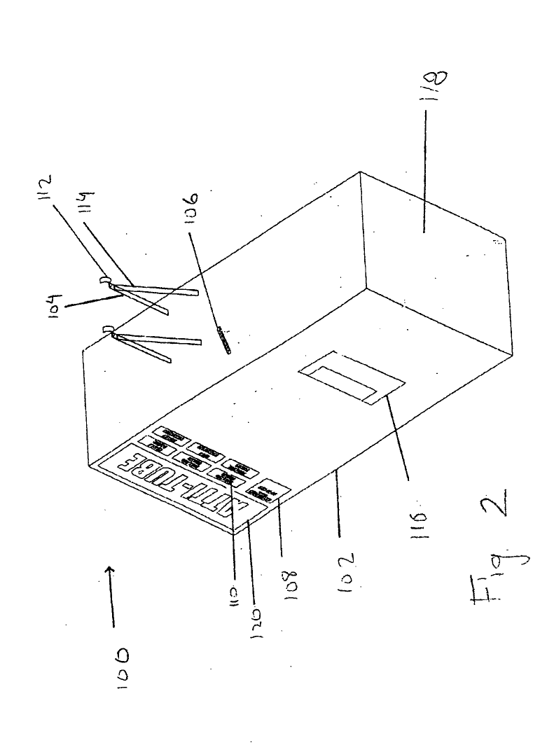

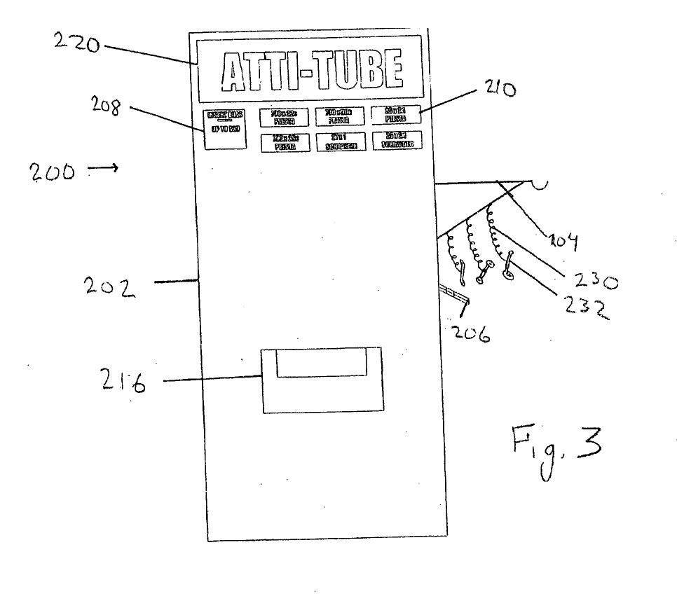

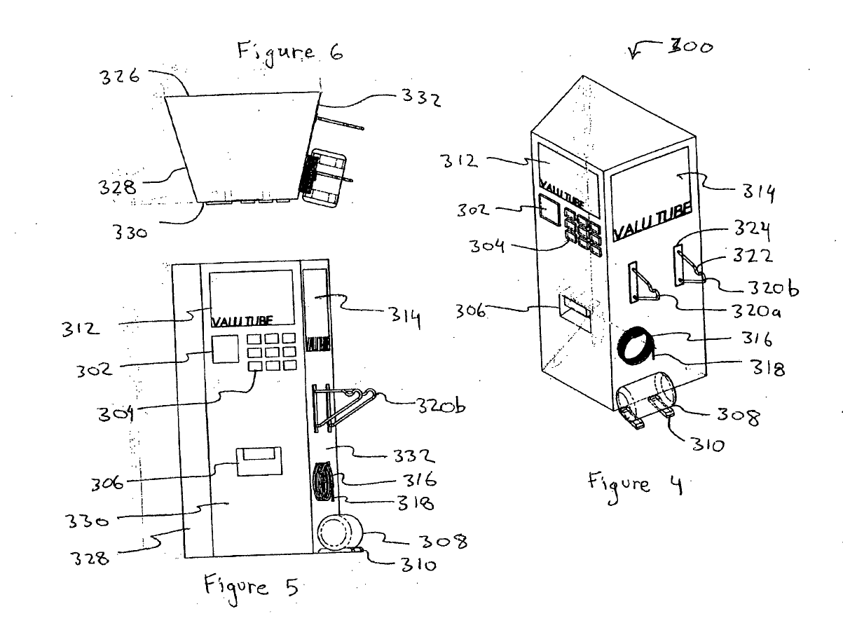

FIG. 4 is an elevational oblique view of a third embodiment of the invention. Device 300 has money receiver 302, selection button 304, dispenser 306, external air compressor 308, compressor feet 310, advertising 312, secondary advertising 314, air hose 316 connected internally to compressor 308, nozzle 318, bike racks 320a and 320b having dip 322 and base plate 324. FIG. 6 is top view of the third embodiment of the invention and FIG. 5 is a front view of the third embodiment of the invention. These views show clearly that the invention need not be confined to a strictly conventional three dimensionally rectangular shape as conventional vending machines are. On the contrary, the device may have any of a wide variety of shapes adapted to the unique needs of the bike repair economic niche. While other embodiments may be suited to the bike repair function and thus may not have any large ‘vending’ body (with the vending functions subsumed into a shape largely dedicated to repair functions) this embodiment is suited to display of advertising on left side 328 and right side 332, which are not set at right angles to front side 330 and rear 326.

This alternative embodiment features the base of the vending structure secured to a base, a concrete pad, concrete apron or other large solid object, (not shown) and either the air compressor or the bike repair station structure or both attached to the same base or concrete pad but seemingly separate from the vending structure. Embodiments in which the device is very securely fastened to a base or other large object are favorable for security reasons.

Power may be supplied by an electrical outlet in areas in which that is available, or it may be by means of solar panels, generator, batteries, combinations thereof or other methods of supplying power to the device in areas in which no electrical outlet is available. This is important when the machine is placed in areas relatively far from urban spaces.

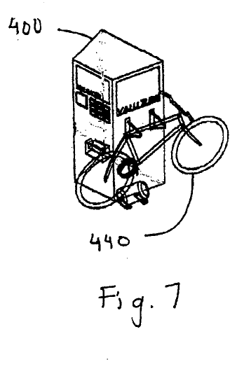

FIG. 7 is an elevational oblique view of an alternative embodiment showing the device in use, with a bicycle on the rack. Embodiment 400 supports bike under repair 440. While bike 440 is shown suspended right side up, it may be upside down (advantageous for working on spokes, etc), sideways, angled, etc.

Note that while several embodiments are shown, numerous other embodiments are possible. The machine may have no air compressor, or it may merely vend tools and may not offer free tools. Tool tethers may be coiled as shown, or may be straight, or like the air hose of the first embodiment, may be retractable into the body of the machine. The machine is depicted as rather like a vending machine with a bike rack attached, however in embodiments it may more resemble a bike rack with only small bodies for the vending structures.

In a method embodiment, the following steps (or a subset or superset thereof) may be employed to vend bike related merchandise at locations frequented by bike users, bicycle traffic or other relatively high volume bicycle use:
a) locating a first place having a relatively high volume of bicycle use; wherein
b) providing at that first place a machine vending such bicycle equipment,
c) providing at least one member selecting from the group consisting of: a bicycle support dimensioned and configured to support a standard bicycle, an air compressor, bicycle repair tools, and combinations thereof;
d) securing the provided devices in a manner sufficient to deter removal; and
e) selling such bicycle equipment by means of the vending machine.

Location of such first place and other places may be handled as a marketing issue, dependant upon personal expertise, marketing studies, etc. Providing the various vending/repair devices discussed is as disclosed in regard to other embodiments.

Selling of bike equipment by means of the vending machine offers a number of advantages. Elimination of human sales clerks offers the opportunity to reduce overhead costs: an otherwise unmanned machine may be serviced at regular intervals. Since only a machine is needed to effect the sale, the points of sale may be dispersed widely rather than concentrated only at a few commercial locations. This also allows location of the sales devices at locations (for example, remote locations) at which sales with human staff would be economically impossible. One important issue is that 24 hour, 7 day a week, 365 day per year sales become possible. As bicyclists frequently exercise when bike stores are closed, this is a significant advantage to the public.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the claims accompanying this application.

1. A bicycle repair station comprising:
a bicycle support dimensioned and configured to support a standard bicycle;
a vending device, the bicycle support and vending device being attached to one another;
at least one bicycle repair tool,
a tether, the bicycle repair being attached to the tether, the tether being attached to one member selected from the group consisting of: the vending device, the bicycle support, and combinations thereof.

2. The bicycle repair station of claim 1, further comprising:
an air compressor attached to one member selected from the group consisting of: the vending machine, the bicycle support.

3. The bicycle repair station of claim 1, wherein the bicycle repair tool is one member selected from the group consisting of: tools optimized for bicycle usage, tire irons, spoke butterflies, wrenches, screw drivers, and combinations thereof.

4. The bicycle repair station of claim 1, wherein the vending device dispenses at least one item selected from the group consisting of: bicycle tires, bicycle inner tubes, bicycle repair tools, bicycle lights, bicycle brake pads, bicycle components and combinations thereof.

5. The bicycle repair station of claim 1, wherein the bicycle repair station has a weight sufficient to deter easy removal.

6. The bicycle repair station of claim 1, further comprising:
a concrete apron, the bicycle repair station secured thereto.

7. A bicycle repair station comprising:
a bicycle support dimensioned and configured to support a standard bicycle;
a vending machine, the bicycle support and vending device being attached to one another;
an air compressor attached to one member selected from the group consisting of: the vending machine, the bicycle support.

8. The bicycle repair station of claim 7, wherein the bicycle repair tool is one member selected from the group consisting of: tools optimized for bicycle usage, tire irons, spoke butterflies, wrenches, screw drivers, and combinations thereof.

9. The bicycle repair station of claim 7, wherein the vending device dispenses at least one item selected from the group consisting of: bicycle tires, bicycle inner tubes, bicycle repair tools, bicycle lights, bicycle brake pads, bicycle components and combinations thereof.

10. The bicycle repair station of claim 7, wherein the bicycle repair station has a weight sufficient to deter easy removal.

11. The bicycle repair station of claim 7, further comprising:
a concrete apron, the bicycle repair station secured thereto.

12. A method of selling bicycle equipment, comprising:
providing a machine vending such bicycle equipment;
providing at least one member selected from the group consisting of: a bicycle support dimensioned and configured to support a standard bicycle, an air compressor, bicycle repair tools, and combinations thereof;
securing the provided devices in a manner sufficient to deter removal; and
selling such bicycle equipment by means of the vending machine.

13. The method of claim 12, further comprising a first step of:
locating a first place having a relatively high volume of bicycle use; wherein the steps of providing devices further comprise providing such devices at the first place.

14. The method of claim 12, wherein the step of selling such bicycle equipment by means of the vending machine further comprises:
selling such bicycle equipment 24 hours a day.

15. The method of claim 12, further comprising the step of:
servicing the vending machine at regular intervals and leaving the vending machine otherwise unmanned.
